(19) United States
(12) Patent Application Publication
(10) Pub. No.: US 2003/0092487 A1
(43) Pub. Date: May 15, 2003

(54) Gaming machine

(76) Inventor: Jason Meyer, Abbotsford (AU)

Correspondence Address: PILLSBURY WINTHROP, LLP, P.O. BOX 10500, MCLEAN, VA, 22102, US

(21) Appl. No.: 10/290,308

(22) Filed: Nov. 8, 2002

(30) Foreign Application Priority Data
Nov. 9, 2001 (AU) PR8773

(51) Int. Cl. A63F 13/00

(52) U.S. Cl. 463/30

(57) ABSTRACT

A gaming machine that displays an array 1 of randomly selected symbols and pays winnings for each winning payline 38. The winning paylines are sequentially identified on the display so that the array 1 can offer a large number of paylines without making the display cluttered or confusing for the player.

### FIELD OF THE INVENTION

The present invention relates to gaming machines. The invention has been developed primarily for computerised gaming machines and will be described herein with reference to that application. However, the invention is not limited to that particular field of use and may be suitable for other applications, such as gaming facilitated by the Internet.

### BACKGROUND OF THE INVENTION

Gaming machines have long been known and are now one of the most common forms of gambling. One of the oldest and best known forms of gaming machine is the rotating reel type “poker machine”. Traditionally, poker machines use a series of three, four or five reels, each reel having symbols on its peripheral edge. The reels are rotated upon the placement of a bet and then stopped to produce an array of randomly selected symbols. Winnings are paid if the random selection of symbols matches one of the predetermined winning combinations.

Gaming machines can “pay winnings” in a variety of ways. These include dispensing money, dispensing tokens that can be redeemed for money, or simply adding credits to a credit meter that can be used for placing future bets or redeemed as money. More recently these gaming machines have been computerised and it is this type of machine that now dominates the industry. Computerised machines usually award winnings in the form of credits tallied on a credit meter. In light of their widespread use, the present invention will be described in the context of this type of winnings payment mechanism. However, those skilled in the art will readily understand that the term encompasses other award payment mechanisms.

Computerised gaming machines use a video screen display instead of physically rotating reels. The display screen typically presents an array of symbols in five columns and three rows equating to the symbols that would normally be seen on the five physically rotating reels of an old style mechanical machine. Computerised machines have allowed players to simultaneously bet on the combination of symbols appearing in many different parts of the array. These parts of the array are often referred to as “paylines” consisting of lines of adjacent symbols extending through the array. The symbols may be laterally adjacent each other or diagonally adjacent each other. They usually extend along each row as well as various angled or “zig zag” lines through the array. This provides a more interesting and exciting game than the old style mechanical machines which traditionally only offered a single payline through the middle row.

Most computerised gaming machines will offer at least five paylines in a five reel array of symbols. However, it has been found that there is an upper limit of about twenty paylines in a five reel array, after which the screen becomes too cluttered and the player has difficulty identifying individual paylines.

### SUMMARY OF THE INVENTION

It is an object of the present invention to overcome or ameliorate at least one of the disadvantages of the prior art, or to provide a useful alternative.

According to a first aspect, the present invention provides a gaming machine including:

a display for presenting an array of randomly arranged symbols, the array having paylines that consist of unique combinations of sites within the array; such that,

winning paylines are any of the paylines with a winning combination of symbols, and carrying a bet; wherein,

the winning paylines are sequentially identified on the display.

According to another aspect, the present invention provides a method of operating a gaming machine having a display, the method including the steps of:

presenting an array of randomly arranged symbols, the array having paylines that consist of unique combinations of sites within the array;

identifying winning paylines as any of the paylines carrying a bet and showing a winning combination of symbols; and

sequentially identifying each of the winning paylines on the display.

The invention allows the use of as many paylines as mathematically possible. By individually highlighting each of the winning paylines in quick succession, rather than simultaneously, up to about 100 paylines can be incorporated into a standard five by three symbol array in a manner that is not confusing to players. Larger arrays of symbols will obviously accommodate even more paylines.

The machine can be configured so that it allows a minimum bet of one or two cents per payline and provide much higher levels of screen activity than a machine that has, say, a one dollar minimum bet and only four or five paylines. In this way, the player gets a more visually exciting game without needing to bet more than they are accustomed to.

Preferably, the paylines are assigned a number, and while the winning paylines are being sequentially identified, the corresponding payline number appears adjacent the ends of the relevant payline on either side of the array.

The vast majority of poker machines number the paylines using numbered line icons that appear at both ends of the corresponding payline. As game designers have generally sought to increase the number of paylines, the space available for line icons remains limited. Reducing the size of the line icons is not practical however the present invention addresses this issue by only showing the winning icons in sequence.

In a still further preferred form, the symbols on each of the winning paylines, and the corresponding payline number on both sides of the array, blink on and off to sequentially identify each of the winning paylines. To identify the different paylines, as well as the particular winning combination of symbols on the payline, the machine may be configured such that only those symbols that are essential to the winning combination of symbols blink on and off while the winning paylines are being sequentially identified. This feature allows the player to quickly appreciate whether the winning combination on any individual payline is a high yielding combination or otherwise. For example, “four of a kind” or “five of a kind” winning combinations are typically high yielding combinations. Therefore, if four or five of the symbols in the payline are flashing as each of the paylines are sequentially identified, the player is quickly aware that the winning combination is a high yielding one compared to, say, two or three of a kind. This visually reinforces any larger wins.

### BRIEF DESCRIPTION OF THE DRAWINGS

A preferred embodiment of the invention will now be described, by way of example only, with reference to the accompanying drawings in which:

FIG. 1 shows a schematic representation of the display screen while the machine is in idle mode;

FIG. 2 shows a schematic representation of the display screen identifying one of the winning paylines; and

FIG. 3 shows a schematic representation of the display screen individually identifying a subsequent winning payline.

### DETAILED DESCRIPTION OF THE PREFERRED EMBODIMENTS

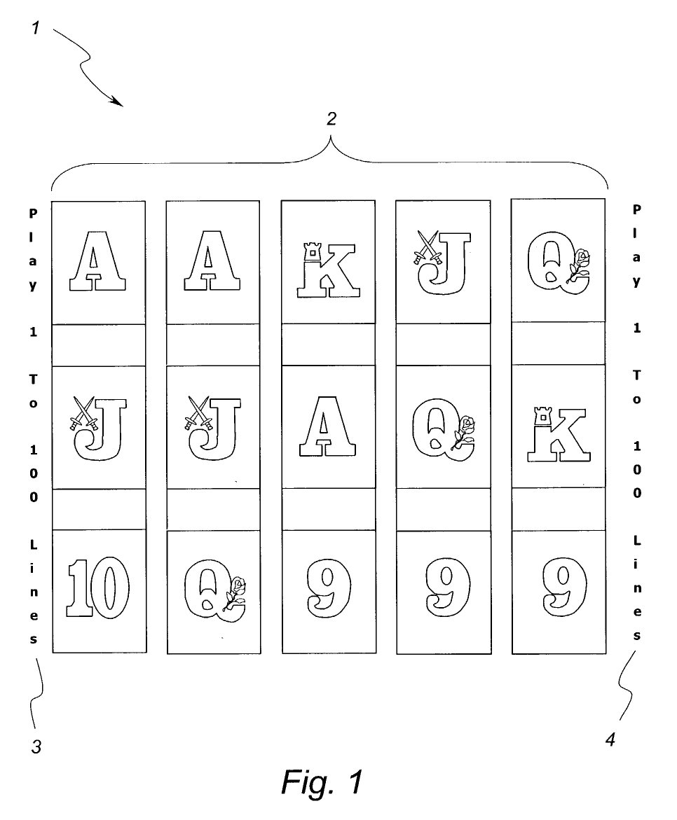

Referring to FIG. 1, the display screen shows an array 1 of symbols in five columns and three rows. The columns are displayed so as to simulate adjacent rotating reels 2 used in the old style mechanical machines. The reels 2 are “spun” and brought to rest to produce a random arrangement of the symbols. The machine pays winnings if any of the paylines carrying a bet show a winning combination at the completion of the spin. All the possible winning combinations are prominently displayed on the facia of the machine or the display screen in a table listing the number of credits won for each particular winning combination.

Along both sides of the reels 2, it is common to display numbered icons which refer to the various paylines that run through the array 1. The numbered payline icons are positioned beside the symbol where the payline begins on one side of the array 1, and beside the symbol on the other side of the array where the payline ends. Because of various practical considerations, the maximum number of paylines in the array is limited to about 20. Any more and the display screen becomes too crowded with the payline icons and the paylines themselves. Players will then have difficulty in identifying individual paylines and the winning combination of symbols on any one of the paylines.

In contrast, the present invention initially dispenses with the payline icons at either side of the array 1, and substitutes signage 3 and 4 informing the player that there are up to 100 paylines available on which they can place a bet. The player chooses the number of paylines on which they bet and the reels 2 “spin” to produce the array 1 of randomly arranged symbols. The machine then determines which of the paylines carrying a bet have a winning combination of symbols, and calculates any corresponding winnings.

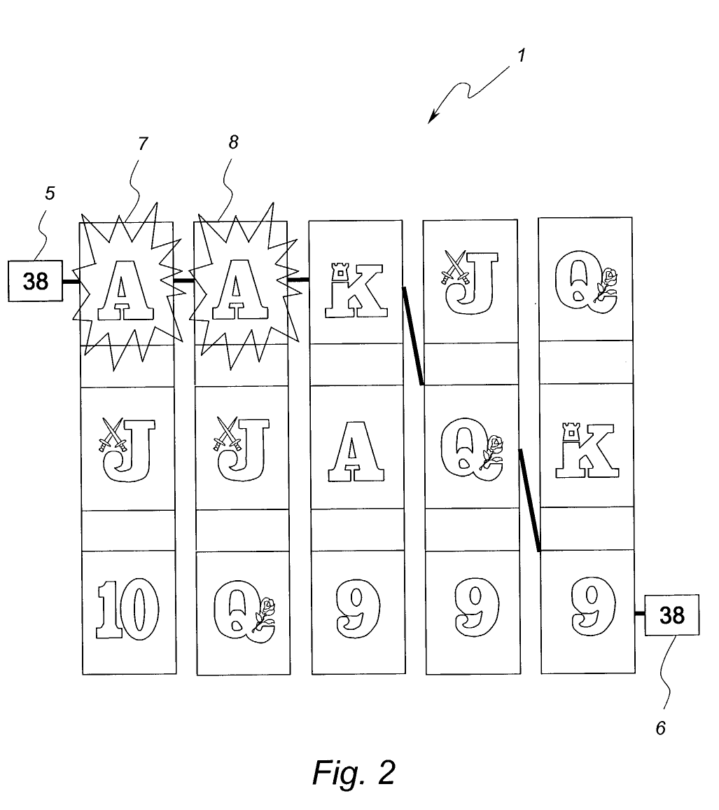

As the machine offers up to 100 paylines, the individual paylines are identified sequentially so that the display screen is not confusingly cluttered. To do this, the signage or side banners 3 and 4 are removed and the winning payline numbers appear in relatively quick succession. As shown in FIG. 2, the payline icons 5 and 6 appear to identify the configuration of winning payline number 38. To assist the player in quickly recognising the type of win on payline number 38, the two symbols 7 and 8 that caused the combination of symbols on payline number 38 to be a winning combination will briefly blink on and off to highlight them from the other symbols in the array. In this way the player is quickly aware if the winning combination is a “two of a kind”, “three of a kind” and so on. This also adds to the screen activity and makes the game more visually engaging.

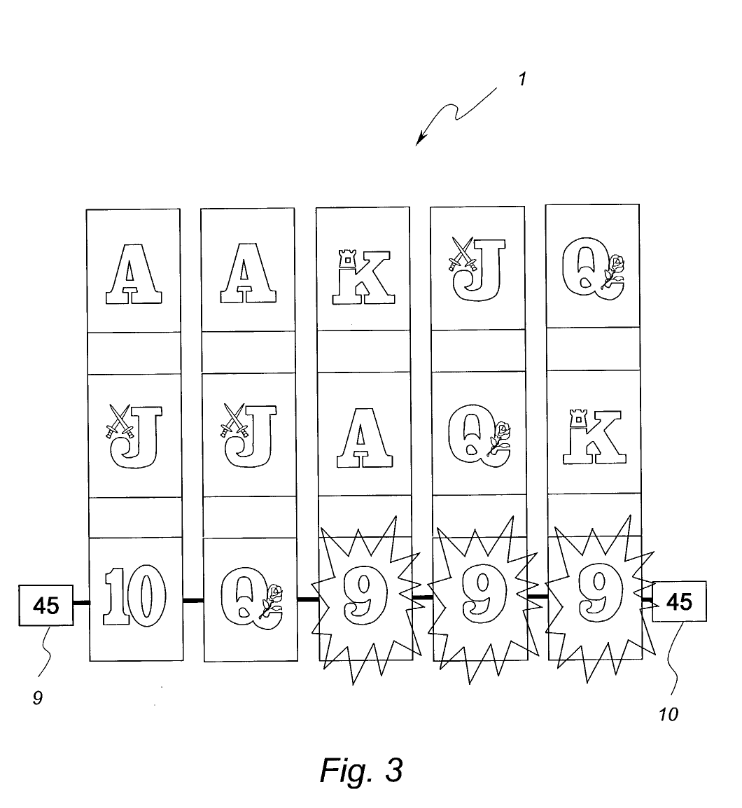

As shown in FIG. 3, payline number 45 is subsequently identified in isolation. The payline icons for payline number 38 have been removed and replaced with icons 9 and 10 for payline number 45. The payline icon 10 for payline number 45 occupies the same position on the screen as the icon 6 for payline number 38. Traditionally, these icons would have been simultaneously displayed on the screen, requiring their own screen area, thereby imposing practical limits on the number of icons that can be shown. By identifying the winning paylines in sequence, the screen area used by each payline icon is no longer a consideration.

The winning paylines may be identified individually, and in quick succession, however, it would also be possible to identify two or more at a time, followed by the next two or more winning paylines. Identifying each winning payline individually is the least confusing or cluttered manner in which to present the winning paylines, however, this does not preclude a machine configured to present two or three winning paylines simultaneously, and then presenting the next two or three winning paylines simultaneously. This may be done without making the screen too confusing or cluttered for the player especially if the array is larger than five by three symbols with more than 100 paylines provided. This will be a matter of balance between screen activity and clear identification of paylines which the game designer needs to resolve for each particular game in view of the target market.

In light of this, it will be understood by ordinary workers in this field that the present invention may identify the paylines as a sequence of the individual paylines and/or in groups of two or more. Therefore, throughout the specification, the terms “sequence” and “sequentially” should be interpreted in that manner.

Using the present invention, it becomes a relatively simple exercise to take existing games that perform well at the 20 to 25 payline level up to a new market. For instance, a game offering 100 paylines at one or two cents minimum bets per line, essentially becomes a one dollar game. However, as a one dollar game it has the advantage of greater game activity. Conventional one dollar games only use three or four paylines which generally involves little screen activity. Hence a 100 payline game with a one or two cent minimum bet will be far more visually interesting for the player, and the frequency of “wins” will be higher, while the actual revenue made from the machine will remain the same.

The present invention also allows games to be designed with 0.1, 0.25 or 0.5 cent minimum bets. This caters for players that are traditionally comfortable betting 20 to 25 cents per spin on the conventional one or two cent machines, but with the added excitement of higher frequency wins and greater screen activity. Furthermore, existing gaming machines are generally easy to modify or upgrade in order to operate in accordance with the invention.

The present invention has been described herein by way of example only. Skilled workers in this field will readily recognise many variations and modifications which do not depart from the spirit and scope of the broad inventive concept.

We claim:

1. A gaming machine including:
a display for presenting an array of randomly arranged symbols, the array having paylines that consist of unique combinations of sites within the array; such that,
winning paylines are any of the paylines with a winning combination of symbols, and carrying a bet; wherein,
the winning paylines are sequentially identified on the display.

2. A gaming machine according to claim 1, wherein the paylines are assigned a number, and while the winning paylines are being sequentially identified, the corresponding payline number appears adjacent the ends of the relevant payline on either side of the array.

3. A gaming machine according to claim 2, wherein the symbols on each of the winning paylines, and the corresponding payline number on both sides of the array, blink on and off to sequentially identify each of the winning paylines.

4. A gaming machine according to claim 3, wherein the machine is configured such that only those symbols that are essential to the winning combination of symbols blink on and off while the winning paylines are being sequentially identified.

5. A gaming machine according to claim 4, wherein the array has more than fifty paylines available for carrying a bet.

6. A gaming machine according to claim 5, wherein the array has a hundred paylines available for carrying a bet.

7. A method of operating a gaming machine having a display, the method including the steps of:
presenting an array of randomly arranged symbols, the array having paylines that consist of unique combinations of sites within the array;
identifying winning paylines as any of the paylines carrying a bet and showing a winning combination of symbols; and
sequentially identifying each of the winning paylines on the display.

8. A method of operating a gaming machine according to claim 7, wherein the paylines are assigned a number, and while the winning paylines are being sequentially identified, the corresponding payline number appears adjacent the ends of the relevant payline on either side of the array.

9. A method of operating a gaming machine according to claim 8, wherein the symbols on each of the winning paylines, and the corresponding payline number on both sides of the array, blink on and off to sequentially identify each of the winning paylines.

10. A method of operating a gaming machine according to claim 9, wherein the machine is configured such that only those symbols that are essential to the winning combination of symbols blink on and off while the winning paylines are being sequentially identified.

11. A method of operating gaming machine according to claim 10, wherein the array has more than fifty paylines available for carrying a bet.

12. A method of operating a gaming machine according to claim 11, wherein the array has a hundred paylines available for carrying a bet.
